(19) United States
(12) Patent Application Publication
(10) Pub. No.: US 2013/0213781 A1
(43) Pub. Date: Aug. 22, 2013

(54) SIDE KEY FOR PORTABLE TERMINAL

(71) Applicant: Samsung Electronics Co., Ltd., (US)

(72) Inventors: Won-Chung LEE, Gyeongsangnam-do (KR); Tae-Won KIM, Gyeongsangbuk-do (KR); Gyung-Up KWON, Gyeongsangbuk-do (KR); Kyung-Chul SEO, Gyeongsangbuk-do (KR); Byung-Wook YU, Seoul (KR)

(73) Assignee: Samsung Electronics Co., Ltd., Gyeonggi-do (KR)

(21) Appl. No.: 13/771,790

(22) Filed: Feb. 20, 2013

(30) Foreign Application Priority Data
Feb. 21, 2012 (KR) 10-2012-0017616

(51) Int. Cl. H01H 9/20

(52) U.S. Cl. CPC H01H 9/20
USPC 200/320

(57) ABSTRACT

A side key of a portable terminal includes a coupling portion inserted into a through-hole formed in the portable terminal from an outer side of the portable terminal and at least one pair of hooks formed on an outer surface of the coupling portion, in which the hooks are formed from an elastic material, pass through the through-hole in a compressed form, and are bound by an inner wall of the portable terminal The side key of the portable terminal may be assembled by being forcedly inserted into the through-hole from the exterior of the portable terminal, such that assembly thereof is easy to perform and the inner space of the portable terminal may be efficiently used.

### CLAIM OF PRIORITY

This application claims, pursuant to 35 U.S.C. §119(a), priority to and the benefit of the earlier filing date of a Korean Patent Application filed in the Korean Intellectual Property Office on Feb. 21, 2012 and assigned Serial No. 10-2012-0017616, the entire disclosure of which is hereby incorporated by reference.

### BACKGROUND OF THE INVENTION

1. Field of the Invention

The present invention generally relates to a portable terminal, and more particularly, to a key provided on a side of a portable terminal

2. Description of the Related Art

Generally, a portable terminal refers to an apparatus for providing a user with various functions: a communication function which allows the user to perform a communication with another user while carrying the portable terminal, such as voice communication or short text message transmission, a data communication function such as Internet, mobile banking, and multimedia file transmission, and an entertainment function such as games, music, and video reproduction. The portable terminal is generally specialized for a particular function such as a communication function, a game function, a multimedia function, or an electronic note function, but recently, with the development of electric/electronic techniques and communication techniques, the user may enjoy various functions merely with a single mobile communication terminal

Such portable terminals include a keypad and a microphone as input devices and a display device and a speaker phone as output devices. In addition, in the prior art, a touch screen function has been provided on the display device and the multimedia function of the portable terminal has been emphasized. Therefore, a combination of a virtual keypad and a touch screen function implemented by the display device replaces a physical keypad, thus achieving miniaturization of the portable terminal while increasing the size of the display device. However, frequently used keys such as a key for returning to a home screen, a volume control key, a hold key and a power key, each of which essentially needs physical manipulation, maintain physical key forms. Moreover, the keypad is implemented with the touch screen display device, such that the physical keys are generally provided on a side of the terminal

FIG. 1 is a perspective view showing a side key 100 of a portable terminal 11 according to an embodiment in the prior art. It should be noted that to more clearly illustrate a structure of the side key 100, the portable terminal 11 is partially shown in a cut-away view of the internal structures of the portable terminal 11.

The side key 100 includes a key cap 101 and an operation protrusion 115 which is formed on an inner side of the key cap 101. The key cap 101 includes a support rib 113 which is formed on a lower end portion and an outer surface of a body 111, such that a portion of the inner side of the key cap 101 forms an inner side of the support rib 113. That is, an edge of the inner side of the key cap 101 is the inner side of the support rib 113. Generally, the body 111 and the support rib 113 are integrally formed from a metallic material or a synthetic resin material.

The side key 100 is inserted from an interior 13 of the portable terminal 11 into a through-hole (not shown in FIG. 1) formed in the portable terminal 11, such that an upper end of the side key 100 is exposed to the outside of the portable terminal 11. In this state, the support rib 113 is supported on an inner wall of the portable terminal 11, thus preventing the side key 100 from being removed from the portable terminal 11. Although not shown in FIG. 1, on the interior 13 of the portable terminal 11, a switch member, for example, a dome switch or a tact switch is disposed adjacent to the side key 100. If a user manipulates the upper end of the side key 100 exposed to the exterior of the portable terminal 11, the operation protrusion 115 operates the switch member for performing key input operations.

The side key 100 in the prior art is assembled into the through-hole from the interior 13 of the portable terminal 11, and to this end, a space for allowing an operator to handle the side key 100 in the assembly process needs to be secured. As a result, there is a limitation in using the inner space of the portable terminal 11 in a position where the side key 100 is disposed. In other words, in the structure of the portable terminal 11 which essentially needs a small size, a light weight, and slimness for portability, the space only for assembly of the side key 100 has to be provided in the interior 13 of the portable terminal 11, degrading the use efficiency of the inner space of the small-size, light-weight, and slim portable terminal 11 and even hindering the miniaturization, lightweightness, and slimness of the portable terminal 11.

### SUMMARY OF THE INVENTION

Accordingly, the present invention provides a side key which contributes to the efficient use of an inner space of a portable terminal.

The present invention also provides a side key of a portable terminal, which is easy to assemble.

The present invention further provides a side key which contributes to miniaturization, lightweightness, and slimness of a portable terminal

According to an aspect of the present invention, there is provided a side key of a portable terminal. The side key includes a coupling portion inserted into a through-hole formed in the portable terminal from an outer side of the portable terminal and at least one pair of hooks formed on an outer surface of the coupling portion, in which the hooks are formed from an elastic material, pass through the through-hole in a compressed form, and are bound by an inner wall of the portable terminal

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a perspective view showing a side key of a portable terminal according to an embodiment in the prior art;

FIG. 2 is a perspective view showing a side key of a portable terminal according to an exemplary embodiment of the present invention;

FIG. 3 is a view for describing a process in which the side key shown in FIG. 2 is assembled to the portable terminal;

FIG. 4 is a view showing a state in which the side key shown in FIG. 2 is assembled to the portable terminal;

FIG. 5 is a cross-sectional view taken along a longitudinal direction to show a state in which the side key shown in FIG. 2 is being assembled to the portable terminal;

FIG. 6 is a cross-sectional view taken along a longitudinal direction to show a state in which the side key has been assembled to the portable terminal shown in FIG. 2;

FIG. 7 is a cross-sectional view taken along a widthwise direction to show a state in which the side key shown in FIG. 2 is being assembled to the portable terminal;

FIG. 8 is a cross-sectional view taken along a widthwise direction to show a state in which the side key shown in FIG. 2 has been assembled to the portable terminal; and

FIG. 9 is a perspective view taken along a widthwise direction to show a state in which the side key shown in FIG. 2 is assembled to the portable terminal

### DETAILED DESCRIPTION OF THE INVENTION

Hereinafter, exemplary embodiments of the present invention will be described with reference to the accompanying drawings. A detailed description of well-known functions and constructions will not be provided if they unnecessarily obscure the subject matter of the present invention. The present invention may, however, be embodied in many different forms and should not be construed as limited to the exemplary embodiments set forth herein. In addition, terms described herein, which are defined with reference to the functions of the present invention, may be implemented differently depending on a user or operator's intention and practice. Therefore, the terms should be understood on the basis of the disclosure throughout the specification. The principles and features of this invention may be employed in varied and numerous embodiments without departing from the scope of the invention.

The same reference numbers are used throughout the drawings to refer to the same or like parts. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

As used herein, the term “side key” is defined to be any type of physical key which extends from any exterior surface of a device, with such an exterior surface being oriented on the top, bottom, left side, right side, front, rear, or other surfaces of a device, such as a terminal and/or an electronic devices, and so the term “side key” is not limited herein to being on a left side or rights side of a device.

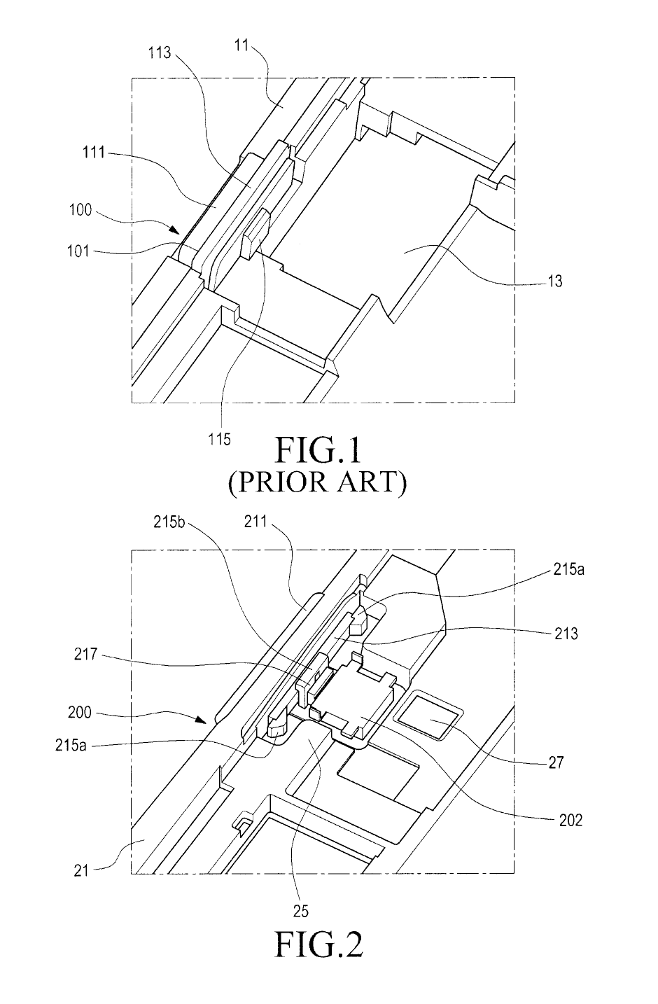

As shown in FIGS. 2 through 4, a side key 200 of a portable terminal 21 according to an exemplary embodiment of the present invention includes a coupling portion 213 and at least one pair of hooks 215a, and may be assembled by insertion of the coupling portion 213 from an outer side of the portable terminal 21.

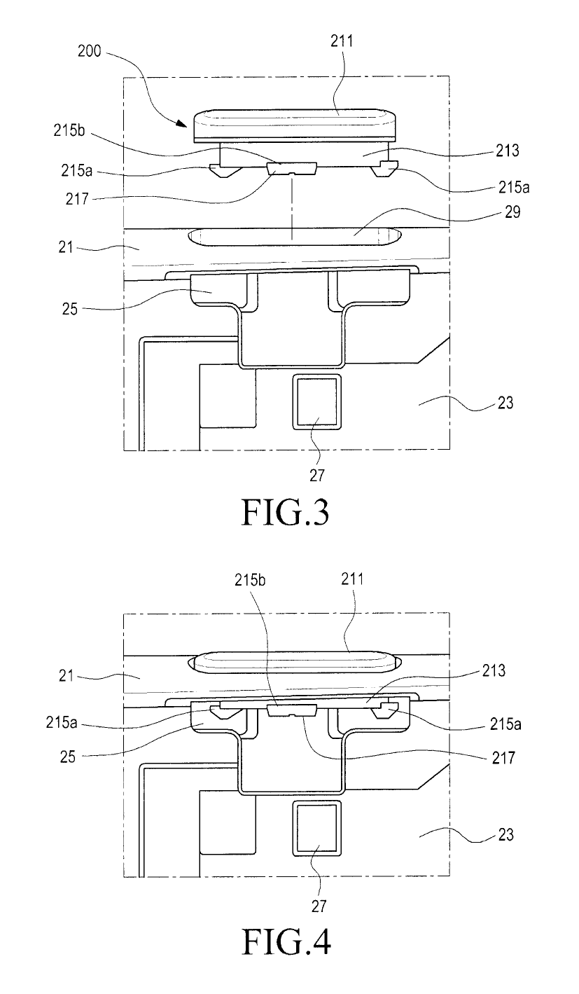

The coupling portion 213 is formed from an elastic material such as silicon or urethane, and has a predetermined width and height by extending in a direction (which will hereinafter be referred to as “a longitudinal direction”). Due to the extending length of the coupling portion 213, the side key 200 is used by moving the side key 200 in a two-way direction which may manipulate one switch member or two or more switch members, internally disposed in the portable terminal 21 and adjacent to, substantially adjacent to, coupled with, or positioned to engage the coupling portion 213. Generally, a power key or a camera shutter key manipulates one switch member and a key used for volume control or menu shift manipulates two independent switch members, but such keys are not limited to one or two switch members. Such a switch member may be a dome switch or a tact switch, or any other known type of switch. In the exemplary embodiment of the present invention, for a switch member 202 shown in FIG. 2, only one tact switch is installed. The coupling portion 213 may have length, width, and height corresponding to a through-hole 29 as shown in FIG. 3, formed in the portable terminal 21 to allow installation of the side key 200.

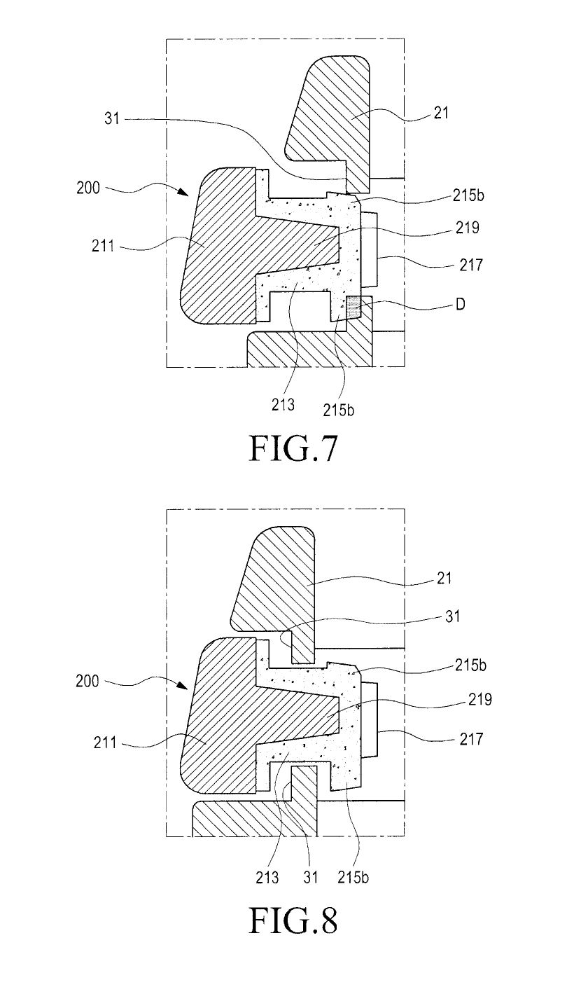

The hooks 215a are formed on an outer surface of the coupling portion 213, and may be formed integrally with the coupling portion 213 in a process of molding the coupling portion 213. That is, the hooks 215a are preferably formed from an elastic material such as silicon or urethane. In the drawings, the hooks 215a are formed on outer surfaces of both ends of the coupling portion 213 along a longitudinal direction of the coupling portion 213 in a way to protrude from the outer surfaces of the coupling portion 213. In addition to the hooks 215a formed on the outer surfaces of the both ends along the longitudinal direction of the coupling portion 213, second hooks 215b, shown in greater detail in FIGS. 7-8, may also be formed on outer surfaces of both sides of the coupling portion 213.

An operation protrusion 217 is formed on an inner side of the coupling portion 213. The operation protrusion 217 protrudes from the inner side of the coupling portion 213, such that when the side key 200 is manipulated by a user, the operation protrusion 217 directly operates or otherwise engages the switch member 202.

As the coupling portion 213 is inserted into a through-hole 29 from the exterior of the portable terminal 21, a portion of the side key 200 is exposed to the exterior of the portable terminal 21 to allow the user to manipulate the side key 200. Thus, in an interior 23 of the portable terminal 21, a structure needs to be provided for restricting further insertion of the side key 200, more specifically, for restricting further insertion of the coupling portion 213 at a predetermined position. This structure may be implemented by forming a separate structure 25 adjacent to the through-hole 29 in the interior 23 of the portable terminal 21 or by using the switch member 202. The structure 25 formed in the interior 23 of the portable terminal 21 may set a position of the coupling portion 213 and contribute to reinforcement of a structural strength of the portable terminal 21.

The side key 200 may further include a key cap 211 provided on the outer side or part of the coupling portion 213; that is, the part of the coupling portion 213 which is exposed externally from a side or surface of the portable terminal 21. The coupling portion 213 may be exposed to the exterior of the portable terminal 21 to allow user manipulation. A general exterior, that is, a housing of the portable terminal 21 is formed, for example, from a synthetic resin or metallic material. However, as mentioned previously, the coupling portion 213 is formed from an elastic material and thus may not be well matched with a color of the housing of the portable terminal 21. To be harmonized with the external design of the portable terminal 21, the side key 200 includes the key cap 211 which may match the color of the housing. The key cap 211 is preferably formed from a synthetic resin or metallic material, or other known materials, and is coupled to the outer side or part of the coupling portion 213. The key cap 211 may also include visible characters, symbols, or other indicia indicating the function of the side key 200.

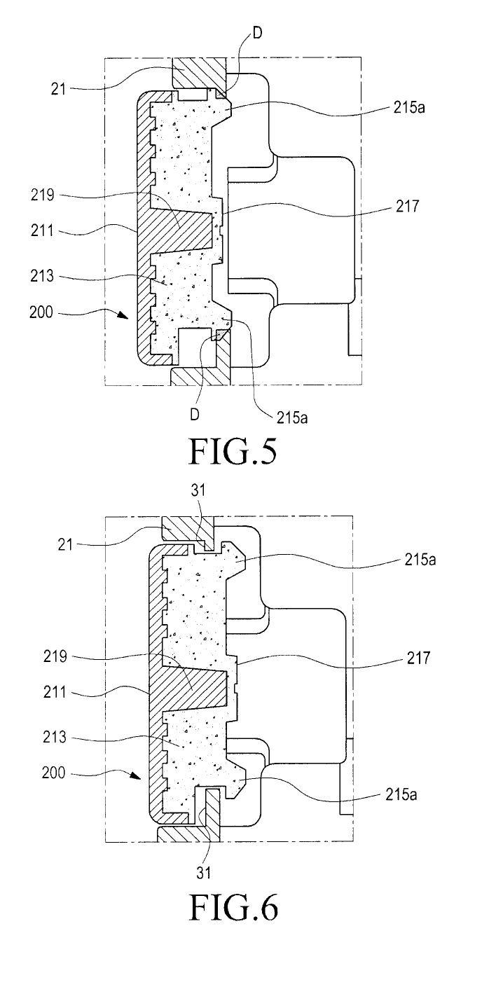

Referring to FIGS. 5 through 9, a binding protrusion 219 may be formed on an inner surface of the key cap 211. The binding protrusion 219 may be formed integrally with the key cap 211. To this end, the key cap 211 and the binding protrusion 219 may be manufactured using injection molding or die casting. The coupling portion 213 is provided to enclose the binding protrusion 219, thus achieving firm binding between the coupling portion 213 and the key cap 211.

The key cap 211 may be coupled to the coupling portion 213 by double injection. That is, after the key cap 211 is molded, the key cap 211 is put into a mold for molding or being formed with the coupling portion 213 and in this state, the coupling portion 213 is molded. Through such double injection, simultaneously with molding of the coupling portion 213, the key cap 211 is coupled to the coupling portion 213.

The key cap 211 and the through-hole 29 may also be used as the structure for restricting further insertion of the coupling portion 213 at the predetermined position, in addition to or instead of the structure 25 or the switch member 202. That is, if the key cap 211 is manufactured to have a larger width or length than the coupling portion 213 and a step surface 31 is formed on an inner end of the through-hole 29 to allow passage of only the coupling portion 213, a distance to which the key cap 211 may be received in the interior of the through-hole 29 is limited. Therefore, the key cap 211 is positioned on an outer side of the step surface 31 formed in the through-hole 29 and a portion of the coupling portion 213 passes the step surface 31 formed in the through-hole 29 and is inserted into the interior 23 of the portable terminal 21.

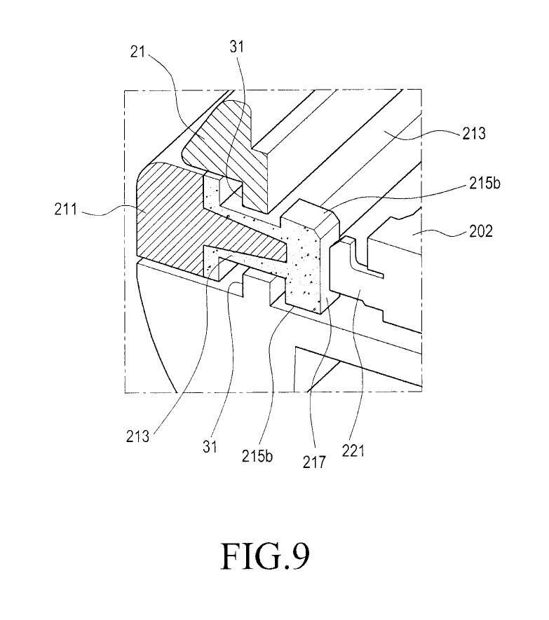

To prevent the key cap 211 from contacting the step surface 31 formed in the through-hole 29 to avoid generation of noise or from eroding the step surface 31 by repeated frictional contact, the coupling portion 213 may be formed to completely enclose the inner side of the key cap 211. That is, the coupling portion 213 made composed of an elastic material which prevents the key cap 211 from directly contacting the step surface 31 formed in the through-hole 29. Such a shape of the coupling portion 213 is more clearly shown in FIG. 9.

FIGS. 5 and 7 show a state when the side key 200 is being assembled into the through-hole 29 of the portable terminal 21. FIGS. 6 and 8 show a state after the side key 200 has been assembled into the through-hole 29 of the portable terminal 21.

As shown in FIGS. 5 through 8, assembly of the side key 200 is achieved by inserting the side key 200 through the through-hole 29 from the exterior of the portable terminal 21. The hooks 215a and 215b are interfered with by the step surface 31 formed in the interior of the through-hole 29. Such interference between the hooks 215a and 215b and the step surface 31 in the through-hole 29 is shown by the shaded region D in FIGS. 5 and 7. In spite of the interference, if the side key 200 is forcedly inserted, the hooks 215a and 215b are compressed such that the coupling portion 213 enters the interior 23 of the portable terminal 21. Once the coupling portion 213, and more specifically, the hooks 215a and 215b completely enter the interior 23 of the portable terminal 21, the hooks 215a and 215b are restored into a shape protruding from the outer surface of the coupling portion 213 and are bound by and supported on or against the inner wall of the portable terminal 21, preventing removal of the side key 200 from the through-hole 29.

As shown in FIGS. 5 through 8, the side key 200 is assembled merely by being inserted from the exterior of the portable terminal 21, such that there is no need to secure a separate space in the interior of the portable terminal for handling the side key 200 in the interior 23 of the portable terminal 21 during fabrication by extending the side key, such as the side key 100 of the prior art in FIG. 1, from the interior to the exterior of the portable terminal, as in the prior art. Therefore, by using a space which, in the prior art, needs to be secured for assembly of the side key 200 in the interior 23 of the portable terminal 21, a part 27 such as a gyro sensor may be installed in the unused space within the portable terminal 21 of the present invention, or alternatively the unused space can be eliminated to reduce the size of the portable terminal 21.

FIG. 9 is a perspective view partially taken to show a state in which the side key 200 shown in FIG. 2 is assembled to the portable terminal 21. The operation protrusion 217 nearly or directly contacts an actuator 221 of the switch member 202. The inner surface of the key cap 211 is maintained spaced apart from the step surface 31 in the through-hole 29. Thus, if the user presses the side key 200 or, more specifically, the key cap 211, the operation protrusion 217 operates the actuator 221, and if the user removes a force of pressing the key cap 211, the actuator 221 returns to an initial position by an elastic force of an elastic member embedded in the switch member 202. In a process of returning to the initial position, the actuator 221 pushes up the operation protrusion 217, such that the key cap 211 also moves away from the step surface 31 formed in the through-hole 29. Alternatively, the portable terminal 21 and/or the side key 200 may include a resilient member independent of or in addition to any restorative force provided by the actuator 221 and/or the switch member 202, for returning the side key 200 to an unpressed position upon removal of the pressing force to the side key 200.

The side key 200 of the portable terminal 21 structured as described above may be assembled by being forcedly inserted into the through-hole 29 from the exterior of the portable terminal 21, such that assembly thereof is easy to perform and there is no need to secure a separate space for handling the side key 200 during the assembly process in the interior 23 of the portable terminal 21. Therefore, in an inner space of the portable terminal 21, which is adjacent to the side key 200, a part 27 such as a gyro sensor may be mounted or a structure for reinforcing the structural strength of the portable terminal 21 may be formed, contributing to efficient use of the inner space of the portable terminal 21. Moreover, if the separate part or structure is not formed in the space secured in the inner space of the portable terminal 21 by providing the side key 200 according to the present invention, the size of the portable terminal 21 may be reduced by the size of the secured space; that is, by eliminating the secured space from the portable terminal 21 using the side key 200 of the present invention.

While the present invention has been particularly shown and described with reference to an exemplary embodiment thereof, various modifications or changes can be made without departing from the scope of the present invention. Therefore, the scope of the present invention is not limited to the disclosed embodiment, and it should be defined by the scope of the following claims and equivalents thereof.

What is claimed is:

1. A side key of a portable terminal, the side key comprising:
a coupling portion inserted into a through-hole formed in the portable terminal from an outer side of the portable terminal; and
at least one pair of hooks formed on an outer surface of the coupling portion;
wherein the hooks are formed from an elastic material, pass through the through-hole in a compressed form, and are bound by an inner wall of the portable terminal

2. The side key of claim 1, wherein the hooks are formed on outer surfaces of a pair of ends of the coupling portion along a longitudinal direction of the coupling portion.

3. The side key of claim 1, wherein the hooks are formed on outer surfaces of a pair of ends of the coupling portion along a longitudinal direction of the coupling portion, and are formed on outer surfaces of a pair of sides of the coupling portion.

4. The side key of claim 1, further comprising an operation protrusion formed on an inner side of the coupling portion.

5. The side key of claim 1, wherein the coupling portion and the hooks are integrally formed from an elastic material.

6. The side key of claim 1, further comprising a key cap coupled to an outer side of the coupling portion.

7. The side key of claim 6, wherein the coupling portion and the hooks are integrally formed from an elastic material.

8. The side key of claim 7, wherein the hooks are formed on outer surfaces of a pair of ends of the coupling portion along a longitudinal direction of the coupling portion.

9. The side key of claim 7, wherein the hooks are formed on outer surfaces of a pair of ends of the coupling portion along a longitudinal direction of the coupling portion and are formed on outer surfaces of a pair of sides of the coupling portion.

10. The side key of claim 7, further comprising an operation protrusion formed on an inner side of the coupling portion.

11. The side key of claim 7, further comprising a binding protrusion protruding from an inner surface of the key cap, wherein the coupling portion encloses the binding protrusion.
